(19) United States
(12) Patent Application Publication
(10) Pub. No.: US 2012/0180442 A1
(43) Pub. Date: Jul. 19, 2012

(54) AIR FILTER FOR A MOTOR VEHICLE

(75) Inventors: Ralf SIBER, Mainz (DE); Juergen Gerhard BECHTOLD, Birkenau (DE)

(73) Assignee: GM GLOBAL TECHNOLOGY OPERATIONS LLC, Detroit, MI (US)

(21) Appl. No.: 13/329,833

(22) Filed: Dec. 19, 2011

(30) Foreign Application Priority Data
Dec. 21, 2010 (DE) 10 2010 055 441.3

(51) Int. Cl. B01D 50/00; B04C 5/103; B04C 5/14; B01D 45/16

(52) U.S. Cl. 55/337; 55/459.1; 55/452; 55/439

(57) ABSTRACT

An air filter is provided for a motor vehicle with an air supplying inlet and an air discharging outlet and with at least one air guiding structure arranged downstream of the inlet that is configured to change the flow direction of supplied air. The air filter further includes, but is not limited to at least one catching device that is arranged tangentially to a curvature of the air guiding structure and configured to separate particles carried along in the air stream

### CROSS-REFERENCE TO RELATED APPLICATION

This application claims priority to German Patent Application No. 102010055441.3, filed Dec. 21, 2010, which is incorporated herein by reference in its entirety.

1. Technical Field

The technical field relates to an air filter, particularly a cooling air filter for use in a motor vehicle, which is configured to filter or separate the particles, particularly water particles carried along in a supplied air stream.

2. Background

The use of air filters is thoroughly known in the motor vehicle sector for example for supplying combustion air to a combustion engine. New type of drive concepts, such as hybrid drives or pure electric drives require the use and the carrying along of energy storage devices, for example of reaction gases for a fuel cell or of powerful accumulators for supplying electric energy to the drive. For a multiplicity of energy storage devices that are possible for realizing the electromobility, an active cooling is required since the operation of powerful electric accumulators but also fuel cells in vehicle operation is accompanied by a heat development that cannot be neglected.

Air-cooling systems are preferably possible for this purpose. An air stream is either artificially generated by a blower or branched off the headwind in the case of a vehicle that is being driven. Particularly for utilizing a so-called RAM-air effect, namely the backing-up of the air through the travelling speed of the vehicle, intake pipes for cooling air to be supplied can be arranged on the vehicle front. In moist weather conditions, for example when the vehicle is moved in rain or with wet road surface, substantial amounts of water or moist air can also be sucked in or supplied to the cooling unit via such intake pipes on the front. Since the energy storage modules to be cooled and possibly designed in the shape of accumulators sometimes react with great sensitivity to moisture, it is essential to reduce the moisture of the supplied cooling air.

At least one object is to provide an air filter, particularly a filter for cooling air, which brings about an effective and simultaneously efficient water separation from the supplied cooling air. Furthermore, the air filter is to be variably adaptable to existing installation space concepts of a motor vehicle and only exert as small as possible a pressure loss on the cooling airflow. In addition, other objects, desirable features, and characteristics will become apparent from the subsequent summary and detailed description, and the appended claims, taken in conjunction with the accompanying drawings and this background.

### SUMMARY

An air filter is provided for a motor vehicle and is particularly designed as filter for supplied cooling air. The air filter comprises an air supplying inlet and an air-discharging outlet. Between inlet and outlet, or downstream of the inlet or upstream of the outlet at least one air guiding structure is arranged, which is designed to change the flow direction of the supplied air or at least deflect the supplied cooling air. For separating particles, particularly fluid particles such as water drops carried along in the cooling air, the air filter comprises at least one catching device tangentially to a curvature of the air guiding structure, which serves to receive or separate the particles carried along in the air stream. Here, the air filter utilizes the centrifugal separator principle.

In that the air stream is deflected, preferably even forced at least in part onto a circular orbit, the particles carried along in the air stream because of their mass or their comparatively high density in comparison with the air are carried radially outward under the influence of the centrifugal force where they ultimately land in the catching device. Depending on the geometrical design of the air guiding structure and the deflection of supplied cooling air brought about by this, water droplets of different size can be specifically trapped at different points of the air guiding structure using a catching device, preferably even a plurality of catching devices, and thus separated from the supplied air stream. The air guiding structure in this case is arranged immediately adjoining the inlet of the air filter supplying the air in order to be able to deflect the fresh air supplied from an intake pipe arranged upstream preferably in a controlled manner.

According to an embodiment, the air guiding structure is concavely curved or substantially designed round. A round air guiding structure in this case relates in particular to the inside of a housing of roughly round shape. Thus, the air stream supplied via the inlet is directed to the inside of an air guiding structure that in itself is of a round design in order to force the cooling air onto a kind or circular orbit at least in sections.

According to a further embodiment, a plurality of catching devices is furthermore arranged along the curvature of the air guiding structure. Because of this, particles, particularly water droplets of a wide range of sizes can be separated or filtered out of the air stream over the entire deflection process of the cooling air. Particles or droplets that are large and heavy in mass are preferably received by catching devices arranged near the inlet in this case, while particles that are lighter and lighter in mass because of their lower mass inertia are only received by catching devices located further back in flow direction. As soon as the particles carried along by the cooling air land in the catching device, they are separately discharged from the catching device so that a repeated enrichment of the air stream with already separated particles can be virtually excluded.

According to a further embodiment, the at least one catching device adjoins the air guiding structure with an orifice section that is oriented tangentially relative to the curvature of the air guiding structure. Here it is provided in particular that the catching device substantially extend over the entire height of the air guiding structure. The air guiding structure or the housing of the air filter has a substantially cylindrical geometry. The air guiding structure with catching devices provided thereon is to be assigned to an outer surface.

According to an embodiment, the catching device facing away from its orifice section has a largely closed approximately blind hole-like structure. Here it can be provided that the catching device extends downstream of its orifice at least in sections parallel to the curvature of the air guiding structure. In this manner, individual part air streams corresponding to the size and orientation of the catching device can transport the particles contained and carried along in the cooling air flow into a pocket trap located outside the orifice section, in which they are largely insulated or separated from the actual cooling air stream.

According to an embodiment, the air filter comprises a housing of curved or round design acting as an air guiding structure, which can more preferably have a cylindrical shape. Based on the housing structure, the inlet supplying the air tangentially leads into the cylinder lateral area of the housing, while an air-discharging outlet is oriented axially, i.e., along a vertical or longitudinal cylinder axis. Here, the outlet based on a curved or round housing structure design is arranged centered or in the middle. The already tangentially supplied cooling air flow on the inlet side is deflected by the housing contour onto a curved approximately circular orbit. In the region of that curvature section, preferably a plurality of catching devices arranged one behind the other in flow direction each branch off the air guiding structure in tangential direction. Depending on the flow velocity and pressure conditions on the inlet or outlet side of the air filter, the air subsequently flows out of the housing in axial direction via the concentrically arranged outlet.

According to an embodiment, the air filter comprises a bottom which, based on the cylinder geometry of the air filter housing, adjoins at least as far as to the at least one catching device in circumferential direction. By means of the bottom, additional water collected for example on the housing bottom through the air flow deflected in axial direction can be supplied separately to the pocket traps located on the edge or outside.

In a further embodiment, it is furthermore provided that downstream of the air discharging outlet at least one filter fleece or a filter fabric is arranged, by means of which further particles carried along in the flow air can be filtered out. Any liquid or moisture collecting on the filter fleece or fabric can also be discharged to the outside via the bottom adjoining the filter fleece and supplied to the catching devices arranged there. In a further embodiment, the bottom between the concentrically arranged outlet and at least one catching device provided radially outside comprises at least one drain groove for any fluid collecting on the filter fleece or fabric. The drain groove can extend for example in radial direction from the inside to the outside. Preferably, however, it has a spiral-like or curved contour so that the fluid supplied to the groove in the middle or radially inside on the filter fleece can be guided radially to the outside, to the pocket traps by means of the air flow deflected at least in sections onto an orbit.

In addition, if the bottom follows a course that is inclined downwards radially to the outside facing the catching device. In this manner, a separate supply of fluids accumulated in the middle or center in the filter to the pocket traps provided on the edge can also be affected subject to gravity or with the assistance of gravity. The at least one catching device comprises a drain arranged below the bottom level. It is more preferably provided that the catching device extends approximately in axial direction downwards over and beyond the bottom in order to be able to receive the fluid supplied via the filter bottom. Here it is more preferably provided that the catching devices of pocket-like design for example at the height of the bottom, approximately aligned with the bottom level, comprise a slit facing to the inside towards the bottom so that the fluid supplied via the bottom and if applicable its water accumulation grooves can be collected in the catching device. Each individual catching device can be coupled to a drain or drain system at its bottom located at the bottom in order to be able to discharge the water collected in each case in the catching device and separated from the air stream in a controlled manner According to another embodiment, the drain can have a drainage channel or a second lower bottom structure specifically provided for this purpose. Insofar, the lower bottom can serve as drainage system for all catching devices and can itself be drained via one or a plurality of drains, if necessary via an outlet valve.

According to a further embodiment, the air filter is provided as cooling air filter. The air-supplying inlet is fluidically connected for example with an intake pipe arranged in the region of the vehicle front.

In addition, it can be provided that the outlet of the air filter can be subjected to a vacuum. Insofar the filter is designed for a suction cooling system, so that a filtration of the supplied air takes place on a suction side. The air filter is particularly provided for the filtration of cooling air, which on the outlet of the air filter serves for example for cooling one or a plurality of electric components, for example accumulators of a fuel cell.

According to a further embodiment, a cooling system is furthermore provided, which comprises at least one channel formed on the air filter on the outlet side, which if required is coupled to a blower in order to actively admit cooling air to an electric or electronic module, particularly one or a plurality of accumulators of a vehicle drive. Finally, a motor vehicle is provided that comprises at least one previously described air filter.

### BRIEF DESCRIPTION OF THE FIGURES

The present invention will hereinafter be described in conjunction with the following drawing figures, wherein like numerals denote like elements, and:

FIG. 1 is a perspective representation of an opened air filter;

FIG. 2 is a top view of the air filter according to FIG. 1 from the top; and

FIG. 3 is a lateral view of the air filter according to FIG. 1 and FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

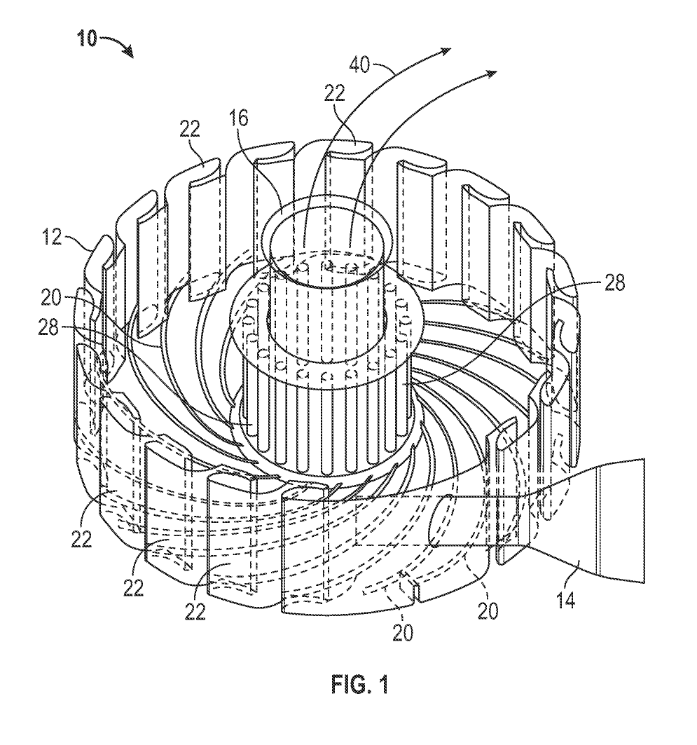

The air filter 10 shown in FIG. 1 to FIG. 3 comprises an air filter housing 12, the lower part of which shown in FIG. 1 to FIG. 3 simultaneously acts as air guiding structure for supplied cooling air 40. The housing 12 in this case has a substantially cylindrical shape. A circumferential side wall of the filter housing 12 is provided with a multiplicity of catching devices 22 acting as pocket traps.

An air supply is affected via an inlet channel 14 running tangentially to the side wall. A discharge of the cooling air by contrast is affected via an axially oriented outlet channel 16 arranged centrally and protruding upwards in FIG. 1. The cooling air 40 flowing into the filter housing 12 is deflected or continuously forced onto a curved trajectory because of the contour and geometry of the air guiding structure or the side wall. The particles 42 contained in the air 40 and carried along therein, particularly water drops and water droplets of a wide range of sizes are received in the individual catching device 22 because of their mass inertia and the centrifugal force principle.

Each of the catching devices 22 comprises an orifice 38 protruding into the side wall in an approximately tangential manner Downstream of the orifice 38 the catching devices 22 however have a curved geometry corresponding to the flow direction. In addition, the catching devices 22 taper towards their free end facing away from the orifice 38, where they are designed largely closed.

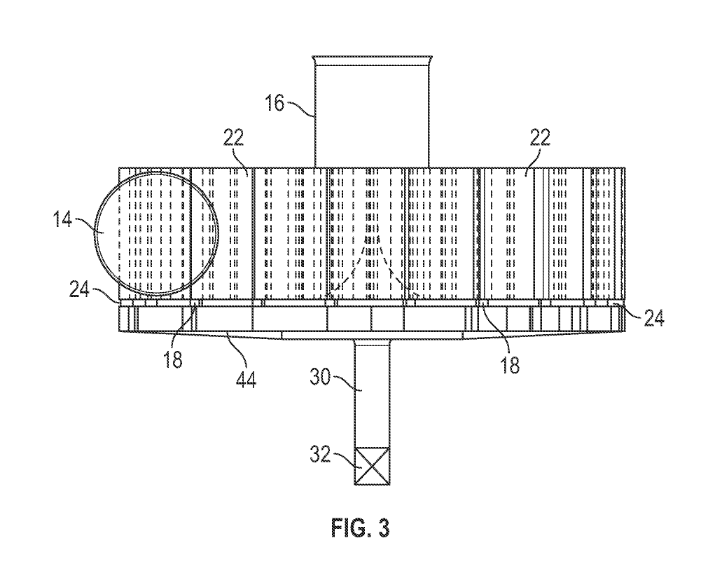

The water droplets or fluid particles introduced into the respective catching device 22 via the orifice 38 are forced to the end section of the catching devices formed in the manner of a blind hole supported by the continuous air 40. However, in this region, the bottom section 34 of the catching devices is provided with a passage opening 36 in order to be able to discharge the water accumulated in the catching devices downwards, for example via a lower bottom 44 shown in FIG. 3 and a drainage channel or drainage hose 30 connected therewith in a controlled manner. The drainage channel or drainage hose 30 is additionally provided with an outlet valve 32 on the outlet side in order to be able to let the accumulated liquid drain off in a controlled manner. The air filter 10 shown in FIG. 1 additionally comprises a bottom 18 arranged above the lower bottom 44, which located radially inside adjoins a circumferential carrier 28 for the filter fleece 26.

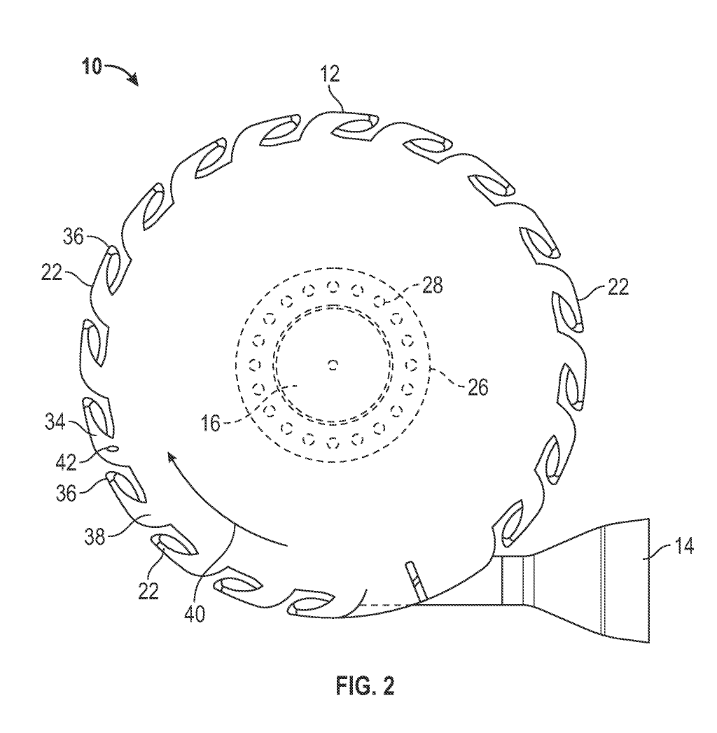

On the fleece carrier 28 a filter fleece 26 indicated in FIG. 2 or a corresponding filter fabric is arranged in order to be able to additionally filter the cooling air 40 to be supplied upstream of the outlet 16 which is protruding upwards. The fleece carrier 28 comprises individually arranged rods or steles arranged equidistantly in a ring-like shape, which is arranged round about the tubular outlet 16 of the air filter 10. The individual rods of the carrier 28 serve as mechanical support and support structure for the filter fleece 26 to be arranged as previously described in this detailed description. Between the catching devices 22 located outside and the fleece carrier 28 located inside a bottom 18 extends, which is provided with individual, spirally curved drainage grooves 20.

The grooves 20 in this case run from radially inside viewed with the flow direction of the supplied cooling air 40. In this manner, any water accumulated on the filter fleece 26 can be supplied to the catching devices 22 via the drainage groove and supported by the cooling air 40 to the outside. In particular, on the end sections of the drainage grooves 20 located radially outside the catching devices 22 are provided with a slit 24 or a filling passage, so that the water directed to the outside via the bottom 18 can be discharged into the respective catching devices 22 where it can be collected.

The catching devices 22 designed as pocket traps thus extend in axial direction over the entire height of the filter housing 12 and additionally fill out the intermediate space between the bottom 18 and the lower bottom 44. The axial extension of that intermediate space between lower bottom 44 and bottom structure 18 in this case determines a maximum filling height of the catching devices 22. The catching devices furthermore serve as ribbing located inside, which impart the air filter or its housing 12 an increased structural stiffness. Separate ribs can thus be omitted.

In this connection, it is noted in addition that the cylindrical or round shape of the air filter deviates from conventional flat filter geometries and makes possible entirely new possibilities regarding the housing of the filter in the motor vehicle. In particular, through the cylindrical or round shape, quite compact air filters can be realized that can be better incorporated in the free installation space of the motor vehicle, which is sometimes available only to a very limited extent, than a flat filter.

The shown air filter comprises a few components preferably to be implemented as injection molded components in each case. Thus, for example the inlet 14, the bottom 18, the housing 12, and a lid that is not shown in the figures can be produced particularly cost-effectively as individual injection molded components and joined with a small number of assembly steps to form an air filter.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An air filter for a motor vehicle
an air supplying inlet;
an air discharging outlet; and
an air guiding structure arranged downstream of the air supplying inlet that is configured to change a flow direction of supplied air; and
a catching device arranged tangentially to a curvature of the air guiding structure that is configured to separate particles carried along in the supplied air.

2. The air filter according to claim 1, wherein the air guiding structure is a concavely curved structure.

3. The air filter according to claim 1, wherein the air guiding structure is substantially round.

4. The air filter according to claim 1, further comprising a plurality of catching devices arranged along the curvature of the air guiding structure.

5. The air filter according to claim 1, wherein the catching device comprises an orifice section oriented tangentially with respect to the curvature of the air guiding structure that adjoin the air guiding structure.

6. The air filter according to claim 5, wherein the catching device is configured to face away from the orifice section and comprises a largely closed blind hole-like structure.

7. The air filter according to claim 4, further comprising a closed housing as the air guiding structure that is a substantially closed housing that at least curved in sections,
wherein the air supplying inlet and the air discharging outlet are arranged tangentially, axially, and centered with respect to the substantially closed housing.

8. The air filter according to claim 1, further comprising a bottom that in circumferential direction adjoins the catching device.

9. The air filter according to claim 8, further comprising a filter fleece arranged upstream of the air discharging outlet.

10. The air filter according to claim 8, further comprising a filter fabric arranged upstream of the air discharging outlet.

11. The air filter according to claim 9, wherein the bottom between the filter fleece and the catching device comprises a drainage groove.

12. The air filter according to claim 10, wherein the bottom between the filter fabric and the catching device comprises a drainage groove.

13. The air filter according to claim 8, wherein the bottom follows an inclined course downwards towards an outside facing the catching device.

14. The air filter according to claim 1, wherein the catching device comprises a drain arranged below a level of the bottom.

15. The air filter according to claim 14, wherein the drain is coupled to a drainage channel that is configured to receive discharge.

16. The air filter according to claim 14, wherein the drain is coupled to a drainage hose that is configured to receive discharge.

17. The air filter according to claim 1, wherein the air discharging outlet is configured for attachment to a vacuum.
